(19) United States
(12) Patent Application Publication
(10) Pub. No.: US 2023/0178778 A1
(43) Pub. Date: Jun. 8, 2023

(54) WATER SUPPLY OXYGENATION SYSTEMS AND METHODS

(71) Applicant: Ohmium International, Inc., Incline Village, NV (US)

(72) Inventor: Arne Ballantine, Incline Village, NV (US)

(21) Appl. No.: 18/076,757

(22) Filed: Dec. 7, 2022

Related U.S. Application Data
(60) Provisional application No. 63/286,817, filed on Dec. 7, 2021.

(51) Int. Cl. H01M 8/0662; H01M 8/04029; C02F 7/00; C25B 1/04; C25B 9/67; C25B 15/08

(52) U.S. Cl. CPC H01M 8/0681; H01M 8/04029; C02F 7/00; C25B 1/04; C25B 9/67; C25B 15/08; H01M 2250/10; C02F 2201/009

(57) ABSTRACT

The present disclosure provides systems and methods for producing a continuous supply of water. The systems generally comprise an electrolyzer module fluidly connectable to a hydrogen storage system and a water-capture unit for generating water, the water-capture unit electrically connectable to a photovoltaic panel and to a hydrogen fuel cell.

### CROSS REFERENCE TO RELATED APPLICATIONS

This application claims priority to U.S. Provisional Application No. 63/286,817 entitled “WATER GENERATION DRIVEN BY SOLAR POWER OR OTHER RENEWABLE GENERATION WITH AIR AS SOLE INPUT SOURCE AND WATER CAPTURE FROM AUXILIARY ENERGY STORAGE OR GENERATION DEVICES” filed Dec. 7, 2021, the contents of which are incorporated by reference herein in their entirety.

### FIELD OF THE DISCLOSURE

The present disclosure is related to systems and methods for generating water via renewable resources. Therefore, the application relates to the fields of chemistry and chemical engineering.

### BACKGROUND

Many systems and industries, such as agriculture, require a continuous supply of pressurized water. Providing the pressurized water requires power for pumping the water to where it is needed. Renewable energy sources, such as solar power, are often intermittent and are therefore unable to provide a continuous power supply for pressurizing the water. What is needed are systems that provide a continuous supply of pressurized water powered by renewable energy sources.

### SUMMARY

Provided herein are systems for generating a continuous supply of water. The systems generally comprise an electrolyzer module to generate hydrogen and oxygen fluidly connectable to a hydrogen storage system and a water-capture unit for generating water. The water-capture unit electrically connectable to a photovoltaic panel and to a hydrogen fuel cell.

In some embodiments, the water capture unit comprises a hydropanel, a dehumidifier, a filtered waste water stream, a rainwater capture system, a river water capture system, a lake water capture system, an ocean capture system, or any combination thereof.

In some embodiments, the systems further comprise an electricity storage system electrically connected to the photovoltaic panel. In some embodiments, the systems further comprise a hydrogen fuel cell. In some aspects, the hydrogen fuel cell is fluidly connected to the hydrogen storage system. In some additional aspects, the hydrogen fuel cell is electrically connected to an electricity storage system. In still further aspects, the hydrogen fuel cell is electrically connected to a pump. In still further aspects, the hydrogen fuel cell provides electricity to the water-capture unit when the photovoltaic panel is not producing electricity.

In some embodiments, the systems further comprise a first pump fluidly connected to the water-capture unit and to the water supply. In some additional embodiments, the systems further comprise a water storage system fluidly connected to the water-capture unit and a second pump fluidly connected to the water storage system and to the water-capture unit.

In some embodiments, the systems further comprise a thermal loop in thermal communication with the electrolyzer module, the thermal loop including a circulating heat exchange fluid. In some aspects, the thermal loop comprises a third pump operable to pump the circulating heat exchange fluid through the thermal loop. In some aspects, the thermal loop further includes a solar thermal system. In still further aspects, the thermal loop further including a heat load.

In some embodiments, the electrolyzer module is operable to provide oxygen to the water supply, thereby increasing the oxygen concentration of the water in the water supply.

Further provided herein are systems for generating a continuous supply of water. The systems generally comprise an electrolyzer module electrically connected to a photovoltaic panel and fluidly connected to a hydrogen storage system, a water-capture unit for generating water, the water-capture unit electrically connected to the photovoltaic panel, a hydrogen fuel cell fluidly connected to the hydrogen storage system and electrically connected to the water-capture unit, and a thermal loop including a circulating heat exchange fluid thermally connected to the electrolyzer module, the hydrogen fuel cell, and a heat load.

Further provided herein are methods for generating a continuous supply of water. The methods may be performed using any of the systems described herein. The methods generally comprise producing hydrogen via an electrolyzer module and producing water via a water-capture unit electrically connected to a photovoltaic panel and to a hydrogen fuel cell. The water-capture unit is powered by the photovoltaic panel when the photovoltaic panel is receiving sunlight. The water-capture unit is powered by the hydrogen fuel cell when the photovoltaic panel is not receiving sunlight. The hydrogen fuel cell produces electricity using the hydrogen produced by the electrolyzer module. In some embodiments, the methods further comprise the produced hydrogen in a hydrogen storage system fluidly connected to the hydrogen fuel cell. In some additional embodiments, the electrolyzer further produces oxygen and the method further comprises diffusing the produced oxygen in a water supply. In still further embodiments, the water-capture unit comprises a hydropanel, a dehumidifier, a filtered waste water stream, a rainwater capture system, a river water capture system, a lake water capture system, an ocean capture system, or any combination thereof. In still further embodiments, the electrolyzer module is electrically connected to the photovoltaic panel.

### BRIEF DESCRIPTION OF THE DRAWINGS

FIG. 1 shows an embodiment of the system of the present disclosure, wherein the photovoltaic panel provides power to the electrolyzer module.

FIG. 2 shows an embodiment of the system of the present disclosure, wherein the photovoltaic panel provides power to both the electrolyzer module and to the water capture unit.

FIG. 3 shows an embodiment of the system of the present disclosure, wherein the photovoltaic panel provides power to the water capture unit.

### DETAILED DESCRIPTION

Described herein are systems and methods for generating a continuous supply of water. The systems of the present disclosure include an electrolyzer module to produce hydrogen that is fluidly connectable to a hydrogen storage system, and a water-capture unit for generating water that is electrically connected to a photovoltaic panel and a hydrogen fuel cell and that is fluidly connectable to a water supply. The water-capture unit is operable to collect water from the environment. The electrolyzer module produces hydrogen for use in a hydrogen fuel cell that is operable to power the water-capture unit and other system components when not powered by the photovoltaic panel to provide a continuous supply of pressurized water. In some aspects, the photovoltaic panel may be electrically connectable to only the electrolyzer module or only to the water-capture unit. In such aspects, the component which is not electrically connectable to the photovoltaic panel may be electrically connectable to another power source as described further herein, including a second photovoltaic panel.

The system comprises an electrolyzer module. The electrolyzer module comprises an electrolyzer stack operable to convert water into oxygen and hydrogen. Electrolyzer stacks (also referred to as electrochemical stacks) and methods of making and procuring electrolyzer stacks are generally known in the art. In particular, electrolyzer stacks suitable for use in the system of the present disclosure are described in U.S. application Ser. No. 17/101,232 (issued as U.S. Pat. No. 11,492,711) entitled “ELECTROCHEMICAL DEVICES, MODULES, AND SYSTEMS FOR HYDROGEN GENERATION AND METHODS OF OPERATING THEREOF”, the entire contents of which are incorporated by reference herein in their entirety. In some embodiments, the system may comprise a plurality of electrolyzer modules.

The electrolyzer stack may comprise a membrane electrolyte such as a proton exchange membrane (PEM). The PEM may comprise any suitable proton exchange (e.g., hydrogen ion transport) polymer membrane, such as Nafion® membrane composed of sulfonated tetrafluoroethylene based fluoropolymer-copolymer having a formula C₇HF₁₃O₅S·C₂F₄.

The electrolyzer stack comprises an inlet operable to receive water from a water source or water reservoir (e.g., municipal water, purified water, etc.). The inlet may therefore be fluidly connected to the water source. The water may be pumped from the water source to the inlet of the electrolyzer stack. Preferably, the water is purified to minimize the amount of impurities introduced into the electrolyzer stack.

The electrolyzer module comprises a first outlet for delivering oxygen. The oxygen may be delivered to an oxygen load or vented to the environment. In some aspects, the oxygen may be delivered to the water supply to increase the oxygen concentration of the water supply. The first outlet may therefore be fluidly connected to the water supply. The electrolyzer module may generate oxygen at a rate of about 1 kg/hr or greater. For example, the oxygen may be generated at a rate of about 1 kg/hr or greater, about 10 kg/hr or greater, about 25 kg/hr or greater, about 50 kg/hr or greater, or about 100 kg/hr or greater. The oxygen may therefore be delivered to the water supply at a rate of about 1 kg/hr or greater. For example, the oxygen may be delivered to the water supply at a rate of about 1 kg/hr or greater, about 10 kg/hr or greater, about 25 kg/hr or greater, about 50 kg/hr or greater, or about 100 kg/hr or greater.

The electrolyzer module also comprises a second outlet operable to deliver hydrogen to a hydrogen load. The second outlet may be fluidly connected to the hydrogen load. The hydrogen load may comprise a dryer, a hydrogen recirculation pump, a hydrogen storage system, or combinations thereof as described further hereinbelow. Preferably, the hydrogen load comprises a hydrogen storage system, which is fluidly connected to the hydrogen fuel cell. The gas flowing from the electrolyzer module through the second outlet preferably consists essentially of hydrogen and water. The hydrogen flowing from the electrolyzer module may have a purity of about 90% to about 99%, or more preferably about 95% to about 99% by weight. For example, the purity of the hydrogen gas may be at least about 95%, at least about 96%, at least about 97%, at least about 98%, or at least about 99% on a weight basis. The impurities of the hydrogen gas flowing from the photo electrolysis array may include oxygen and water.

The electrolyzer module may receive input energy (i.e., electricity) from an intermittent source such as solar power (including photovoltaic and reflective), wind power, tidal power, wave power, batteries, and other intermittent energy sources known in the art and combinations thereof. Alternatively, or in addition, the electrolyzer stack may receive input energy from a non-intermittent source, such as an electricity grid (e.g., a regional electricity grid, a municipal electricity grid, or a microgrid), natural gas, coal, nuclear, and other non-intermittent sources known in the art and combinations thereof. The electrolyzer stack may therefore be electrically connectable to an intermittent energy input, a non-intermittent source, or a combination thereof. In particular embodiments, the electrolyzer module may receive input energy from the photovoltaic panel which also powers the water-capture unit.

The system further comprises a water-capture unit. The water-capture unit is operable to generate water from the ambient environment, such as from the air or from a natural water source. The water-capture unit is preferably electrically connectable to the photovoltaic panel. The water-capture unit is also fluidly connectable to the water supply. The water-capture unit may include a dehumidifier, which condenses water that is in the air. The water-capture unit may include a filtered waste-water stream, such as a sewage stream or industrial waste stream that has been filtered and/or purified. The water-capture unit may include a rainwater capture system, which captures raindrops. The water-capture unit may also capture water from a river, lake or ocean; for example, at times of high water such as after a rain or at high tide the water capture-unit may capture overflow water for use in the system of the present disclosure.

Preferably, the water capture unit includes a hydropanel. Hydropanels are a combination of a photovoltaic panel and a water condenser. Hydropanels function by producing electricity to power one or more fans. The fans draw in ambient air, which is pushed through a hygroscopic material, trapping the water vapor in the air. The water vapor is extracted and passively condenses into a liquid that is collected in a reservoir. Hydropanels and methods of making and procuring hydropanels are generally known to those having ordinary skill in the art. In a preferred embodiment, the hydropanel is a SOURCE® hydropanel.

The water-capture unit may include any one or a combination of the aforementioned devices, as well as any other water-capture units known to those having ordinary skill in the art. The system may comprise a plurality of water-capture units.

A photovoltaic panel provides electric power to the water-capture unit. Photovoltaic panels and methods of making and using photovoltaic panels are generally known to those having ordinary skill in the art. The photovoltaic panel may consist of a single photovoltaic cell or may comprise a plurality of photovoltaic cells. In some embodiments, the system comprises a plurality of photovoltaic panels electrically connected to the water-capture unit and to other system components. If an excess of electricity is generated by the photovoltaic panel, the excess electricity may be routed to other system components, such as the electrolyzer module, an energy storage system (e.g., a battery), one or more pumps, etc. Preferably, the photovoltaic panel also provides power to the electrolyzer module.

The water-capture unit may also receive input energy (i.e., electricity) from another intermittent source such as solar power (including photovoltaic and reflective), wind power, tidal power, wave power, batteries, and other intermittent energy sources known in the art and combinations thereof. Alternatively, or in addition, the water-capture unit may receive input energy from a non-intermittent energy input, such as an electricity grid (e.g., a regional electricity grid, a municipal electricity grid, or a microgrid), natural gas, coal, nuclear, and other non-intermittent sources known in the art and combinations thereof. The water-capture unit may therefore be electrically connectable to an intermittent energy input, a non-intermittent energy input, or a combination thereof.

The water-capture unit receives electricity from the photovoltaic panel when the photovoltaic panel is receiving sunlight (e.g., during the day with little or no cloud cover). When the photovoltaic panel is not receiving sunlight (e.g., at night), the water-capture unit receives electricity from a hydrogen fuel cell powered by the hydrogen produced by the electrolyzer module. This arrangement advantageously allows for the water-capture unit to operate continuously and to provide a continuous supply of water produced entirely by renewable energy. When the water-capture unit comprises a dehumidifier or a hydropanel, the only input other than the water provided to the electrolyzer is air.

The system further comprises a water supply. The water supply is in fluid communication with the water-capture unit such that the water-capture unit provides water to the water supply. Preferably, the water supply includes pressurized water. The water supply may be a municipal water supply, a water supply for aquaculture (e.g., a shrimp farm), or other water supplies. The water supply may comprise a pipeline that includes flowing water. Alternatively, the water supply may comprise stagnant water. In embodiments where the water is a wastewater supply, the system may be operable to increase the oxygen concentration of the water to disrupt bacterial growth and to facilitate oxidation of organic effluents contained in the wastewater supply. A wastewater supply may include, for example, sewage or water wastewater from an industrial facility. In embodiments where the water supply is a water supply for aquaculture, the system is operable to increase the oxygen concentration of the water to provide oxygen for the growth, survival, and health of the aquaculture species.

In some embodiments, the system may comprise a plurality of water supplies. In such embodiments, each of the plurality of water supplies may be fluidly connected to one or more electrolyzer modules and/or to one or more water-capture units.

The system may further comprise one or more pumps operable to produce a pressurized water supply or to deliver the water produced by the water-capture unit to a pressurized water supply. The pump(s) may be fluidly connected to water-capture unit and to the water supply. Pumps suitable for this purpose may include any pumps known in the art, such as positive displacement pumps, centrifugal pumps, and axial flow pumps. Those having ordinary skill in the art will appreciate that parameters such as inlet pressure, outlet pressure, temperature, and others will determine the size and power of the pump needed.

The system may further comprise a first valve in fluid communication with the water capture unit and the water supply. The valve may be operable to direct the flow of water to the water supply. Thus, the valve is operable to modify the flow rate of the water to the water supply. The valve may be any valve known to those having ordinary skill in the art, such as a globe valve, gate valve, ball valve, butterfly valve, diaphragm valve, plug valve, needle valve, angle valve, pinch valve, slide valve, flush bottom valve, solenoid valve, control valve, flow regulating valve, back pressure regulating valve, y-type valve, piston valve, pressure regulating valve, or a check valve. The system may comprise a plurality of valves, particularly when the system comprises a plurality of electrolyzer modules, when the system comprises a plurality of water-capture units, and/or when the system comprises a plurality of water supplies.

The valve may be electrically connected to a controller. The valve may modify the flow rate of water to the water supply based on instructions received from the controller. This may be accomplished by a opening or closing the valve in response to a signal received from the controller.

The valve may be open sufficient to provide a first portion of the water generated by the water-capture unit to the water supply and a second portion of the water to a water storage system. Water storage systems may include tanks or vessels. Water storage systems and methods of making and procuring water storage systems are generally known to those having ordinary skill in the art.

The system may further comprise a second valve in fluid communication with the first outlet of the electrolyzer module and the water supply and/or with the water-capture module. The valve may be operable to direct the oxygen of water to the water supply and/or to the water-capture module. Thus, the valve is operable to modify the flow rate of the water to the water supply. The valve may be any valve known to those having ordinary skill in the art, such as a globe valve, gate valve, ball valve, butterfly valve, diaphragm valve, plug valve, needle valve, angle valve, pinch valve, slide valve, flush bottom valve, solenoid valve, control valve, flow regulating valve, back pressure regulating valve, y-type valve, piston valve, pressure regulating valve, or a check valve. The system may comprise a plurality of valves, particularly when the system comprises a plurality of electrolyzer modules, when the system comprises a plurality of water-capture units, and/or when the system comprises a plurality of water supplies.

The valve may be electrically connected to a controller. The valve may modify the flow rate of oxygen to the water supply and/or to the water-capture unit based on instructions received from the controller. This may be accomplished by a opening or closing the valve in response to a signal received from the controller. The flow rate of water may be modified in according to a predetermined schedule, in response to the oxygen concentration in the water supply reaching a predetermined threshold concentration, or in response to a direct request from a client or customer.

The system may further comprise an oxygen load suitable for using the oxygen generated by the electrolyzer module. Oxygen loads may include manufacturing (e.g., steel, plastics, glass, ceramics, textiles, etc.), industrial brazing, welding, or cutting processes, life support systems for medical or other uses (e.g., aircraft, submarine, spacecraft, diving), chemical processes, pharmaceutical processes, oxidation processes (e.g., gold leaching in gold mining), and others known to those having ordinary skill in the art.

The system may further comprise an oxygen sensor operable to measure the concentration of oxygen in the water supply and/or in the water-capture unit. In some aspects, the system may comprise a plurality of oxygen sensors. The oxygen sensor may communicate the concentration of oxygen in the water supply and/or in the water-capture unit to a controller, which may then increase or decrease the flow of oxygen into the water supply and/or into the water-capture unit if the oxygen concentration is above or below a predetermined value.

In some aspects, the system may introduce oxygen to the water supply at more than one location. Thus, the first outlet of the electrolyzer module may be fluidly connected to the water supply at more than one location. In particular, if the water supply comprises a pipeline, this arrangement may be useful to achieve a more uniform oxygen concentration in the pipeline. In such embodiments, the system may include a plurality of valves to control the flow of oxygen into the water supply at each location.

This arrangement may also be useful to disrupt the growth of bacteria in the water supply by creating an oxygen concentration gradient along the length of the pipeline. Without wishing to be bound by any particular theory, increasing and decreasing the oxygen concentration along the length of the water supply may disrupt the growth of bacteria. At the first location where oxygen is introduced to the water supply, the oxygen concentration of the water supply may rapidly increase and then gradually decrease as the water moves further down the pipeline. The oxygen concentration may decrease due to consumption or oxidation reactions taking place along the length of the pipeline. At the second location where oxygen is introduced to the water supply, this oxygen concentration gradient is repeated. Those having ordinary skill in the art will appreciate that the oxygen concentration gradient may be modified by increasing or decreasing the flow rate of the oxygen into the water supply and increasing or decreasing the distance between the two locations where the oxygen is introduced to the water supply.

The system may further comprise an oxygen storage system. The electrolyzer module may be fluidly connectable to the oxygen storage system. The water supply may also be fluidly connectable to the oxygen storage system. The oxygen storage system may be operable to provide an uninterrupted flow of oxygen to the water supply when the electrolyzer module is not generating oxygen (e.g., during maintenance or shut down of the electrolyzer module). In embodiments where the system includes the valve, the valve may be operable to redirect all or a portion of the flow of oxygen to or from the oxygen storage system; i.e., the valve may be operable to distribute the flow of oxygen between the oxygen storage system and the water supply.

The system may further comprise a diffuser. The diffuser is operable to disperse the oxygen in the water supply such that the oxygen is dissolved in the water. Devices for diffusing oxygen in water and methods of making and procuring the same are generally known in the art. The diffuser may comprise a microbubble diffuser, an atomizer, a sparser, coarse bubble aerators, fine bubble aerators, or other devices suitable for diffusing oxygen in water. The system may comprise a plurality of diffusers, particularly when the system comprises a plurality of electrolyzer modules and/or a plurality of water supplies.

The electrolyzer module may further comprise a dryer. The dryer may be, for example, a pressure swing adsorption (PSA) system, a temperature swing adsorption (TSA) system, a hybrid PSA-TSA system, or a membrane purifier. The dryer may comprise an inlet portion and an outlet portion. The dryer may include one or more beds of a water-adsorbent material, such as activated carbon, silica, zeolite or alumina. The dryer may include a membrane such as a PEM electrolyte. The inlet portion is operable to receive hydrogen from the electrolyzer stack. The inlet portion may therefore be fluidly connected to the electrolyzer stack. The outlet portion is operable to provide dry hydrogen to a hydrogen load such as a hydrogen recirculation pump, a hydrogen fuel cell, and/or a hydrogen storage system. The outlet portion may therefore be fluidly connected to the hydrogen recirculation pump, the hydrogen fuel cell, and/or the hydrogen storage system. The dryer may also comprise a second outlet comprising low pressure hydrogen, e.g., from about 1 to about 2 bar, or less than about 1 bar.

The dryer may further comprise a purge stream. The purge stream is operable to remove excess water vapor and other gases, including oxygen, from the hydrogen. The purge stream may comprise hydrogen having a concentration from about 5% to about 25%. The balance of the purge stream may comprise water and oxygen. The purge stream may be fluidly connected to the water supply or to the atmosphere.

The electrolyzer module may further comprise a hydrogen recirculation pump. Hydrogen recirculation pumps and methods for procuring or making hydrogen recirculation pumps are generally known in the art. In particular, hydrogen recirculation pumps suitable for use in the system of the present disclosure are described in U.S. application Ser. No. 17/101,232 entitled “ELECTROCHEMICAL DEVICES, MODULES, AND SYSTEMS FOR HYDROGEN GENERATION AND METHODS OF OPERATING THEREOF”, filed Nov. 23, 2020, the entire contents of which are incorporated by reference herein in their entirety.

The hydrogen recirculation pump may be, for example, an electrochemical pump. As used in this context, an electrochemical pump shall be understood to include a proton exchange membrane (i.e., a PEM electrolyte) disposed between an anode and a cathode. The hydrogen recirculation pump may generate protons moveable from the anode through the proton exchange membrane to the cathode form pressurized hydrogen.

The hydrogen recirculation pump may be operable to improve the purity of the hydrogen. For example, the hydrogen flowing from the hydrogen recirculation pump may have a purity of about 98% to about 99.999%, such as from about 98% to about 99%, about 98% to about 99.9%, about 98% to about 99.99%, about 98% to about 99.999%, about 99% to about 99.999%, about 99.9% to about 99.999%, or about 99.99% to about 99.999%. The major impurities of the hydrogen flowing from the hydrogen recirculation pump may include oxygen and water.

The hydrogen load may comprise a hydrogen storage system. Systems and methods for storing hydrogen are generally well-known in the art and include, for example, storage tanks and vessels. The electrolyzer module may be fluidly connectable to the hydrogen storage system. The electrolyzer module may be fluidly connected to the hydrogen storage system. The hydrogen storage system may comprise pressurized hydrogen. The pressurized hydrogen may be stored at a pressure from about 350 bar to about 700 bar; for example, about 350 bar, 400 bar, 450 bar, 500 bar, 550 bar, 600 bar, 650 bar, or about 700 bar.

The electrolyzer module may further comprise power electronics. The power electronics may be formed or provided in a single assembly that connects input energy, the electrolyzer stack, and/or additional energy outputs or energy loads. The power electronics may be operable to connect to DC energy inputs, AC energy inputs, and combinations thereof. The power electronics may further be operable to connect to DC energy loads, AC energy loads, and combinations thereof. Further, the power electronics may allow for direct delivery of energy inputs to the energy loads in parallel with the operation of the energy storing electricity generator during times when those energy input sources are available. This is particularly useful when the energy inputs comprise intermittent energy sources. The power electronics may comprise a GaN inverter board, an integrated power board, control cards, a display board, and/or a DAB converter, one or more transformers, one or more rectifiers, etc.

The electrolyzer module may be operational receiving electricity from the photovoltaic panel. At night, the electrolyzer module may be shut down to conserve electricity, or the electrolyzer module may be electrically connected to another power source to continue producing hydrogen at night. In particular, the electrolyzer module may be electrically connected to a power grid such as a regional power grid, a municipal power grid, or a micro grid, and the electrolyzer module may run when the price of electricity is low.

The system may further comprise an energy storage mechanism or a plurality of energy storage mechanisms. The energy storage mechanism may comprise any mechanism or apparatus operable to store energy such as electricity, thermal energy, etc. For example, the energy storage mechanism may include batteries (e.g., lead-acid batteries, lithium-ion batteries, lithium iron batteries, etc.), ice, water, flywheels, compressed air, pumped hydroelectric, or other energy storage mechanisms known in the art and combinations thereof.

The system may further comprise a controller. The controller may be electrically connected to one or more of the system components described hereinabove. The controller is operable to adjust various parameters of the system and the components of the system based on various inputs received, such as temperature, flow rate, pressure, current, etc. The controller may also be operable to turn one or more system components off and on.

The system of may further comprise an elevated water tank. The elevated water tank may be in fluid communication with the water supply and with the water-capture unit. In some embodiments, the elevated water tank may comprise a water tower. Water collected from the water-capture unit may be pumped to the top of the water tower and stored there, thus creating water pressure.

Alternatively, the system may comprise a water accumulator to store pressurized water without elevating the water. Such water accumulators and methods of making and procuring water accumulators are generally known to those having ordinary skill in the art. The accumulator may be fluidly connected to the water-capture unit.

The system of the present disclosure may further comprise a thermal loop. The thermal loop comprises pipes, valves, and other instrumentation necessary to circulate a heat exchange fluid to the various system components thermally connected to the thermal loop. Each system component thermally connected to the thermal loop may be connected to the thermal loop via one or more heat exchangers, such as shell and tube heat exchangers, plate heat exchangers, plate and shell heat exchangers, adiabatic wheel heat exchangers, plate fin heat exchangers, finned tube heat exchangers, pillow plate heat exchangers, phase-change heat exchangers, and other heat exchangers known in the art. Thus, the systems of the present disclosure my include one or a plurality of heat exchangers. As used herein, a “heat load” is defined as a device, system, or process that requires an input of thermal energy to function. The heat load may include air heating systems, water heating systems, and other systems that require heat.

The system may use various heat exchange fluids. The heat exchange fluid is included in the thermal loop and is operable to absorb thermal energy from system components that produce heat (e.g., solar thermal system, electrolyzer module, hydrogen fuel cell, reactor, etc.) and release thermal energy to system components that absorb or release heat (e.g., the radiator, solar thermal system when acting as a radiator, etc.). Heat exchange fluids useful in the systems of the present disclosure are generally known to those having ordinary skill in the art. In some embodiments, the heat exchange fluid may be a molten salt, such as nitrate salts (e.g., lithium nitrate, sodium nitrate, potassium nitrate), chloride salts, fluoride salts, and other molten salts suitable for heat exchange known in the art. In other embodiments, the heat exchange fluid may include water, glycol, and combinations thereof.

The thermal loop may be in thermal communication with the electrolyzer module. The thermal loop may include a pump to circulate the heat exchange fluid through the thermal loop. The pump may be any pump known in the art suitable for circulating the heat exchange fluid. For example, the pump may be a positive-displacement pump, a centrifugal pump, or an axial-flow pump.

In an exemplary embodiment, the pump is a heat pump which is operable to provide additional thermal energy to the heat exchange fluid. Heat pumps and methods of making and procuring heat pumps are generally known to those having ordinary skill in the art. The heat pump functions by recirculating the heat exchange fluid through the thermal loop and further adding heat to the heat exchange fluid when necessary. The heat pump is preferably electrically powered and thus is preferably electrically connected to the photovoltaic panel and/or a hydrogen fuel cell. Alternatively or additionally, the heat pump may be electrically connected to a power grid such as a regional power grid, a municipal power grid, or a micro grid.

The thermal loop further may further comprise a solar thermal system. Solar thermal systems and methods of making and procuring solar thermal systems are generally known in the art. Solar thermal systems generate thermal energy using sunlight, generally by directing the sunlight using mirrors onto an absorber. The thermal energy may then be transferred to the heat exchange fluid in the thermal loop. Therefore, the solar thermal system is thermally connected to the thermal loop. Additionally, the solar thermal system may configured to operate as a radiator when the solar thermal system is not generating heat, i.e., when the sun is not shining (e.g., at night or during periods of heavy cloud cover). This may be useful to release heat from the integrated system when the heat is not needed. In some embodiments, the system comprises a plurality of solar thermal systems thermally connected to the thermal loop.

The system may further comprise a radiator. Radiators and methods of making and procuring radiators are generally known to those having ordinary skill in the art. The radiator functions to release thermal energy to the atmosphere and away from the system as needed, such as when the heat load is not functioning. The radiator may be in thermal communication with the heat load and/or the heat pump. In some embodiments, the system comprises a plurality of radiators. Preferably the electrolyzer module is in thermal communication with the radiator either via the thermal loop or in direct thermal communication with the radiator.

The thermal loop may further comprise a reactor. The reactor may require heat and/or hydrogen in order to function, and one or both may be provided by the system described herein. Additionally, the reactor may require electricity to function, which may also be provided by the photovoltaic panel, the hydrogen fuel cell, and/or the energy storage system of the integrated system of the present disclosure. The reactor may be any reactor known in the art, such as a catalytic reactor, continuously stirred tank reactor, a plug flow reactor. Preferably, the reactor comprises a catalytic reactor. In an example, the catalytic reactor performs catalytic combustion of hydrogen gas produced by the electrolyzer module, which produces heat at very high efficiency.

The system may further comprise a hydrogen fuel cell. The hydrogen fuel cell is operable to produce electricity by combining hydrogen and oxygen to form water. The hydrogen fuel cell generally produces heat while functioning, and thus may be in thermal communication with the thermal loop to provide cooling to the fuel cell. Hydrogen fuel cells and methods of making and procuring hydrogen fuel cells are generally well known in the art. Preferably, the hydrogen fuel cell is a proton-exchange membrane fuel cell.

The hydrogen fuel cell may be in electrical communication with the electrolyzer module, the photovoltaic panel, the energy storage system, and/or one or more pumps in the system of the present disclosure. The hydrogen fuel cell may be fluidly connected to the electrolyzer module and/or the hydrogen storage system. The hydrogen fuel cell may further be used to provide electricity to a load such as a pump, a reactor, or another system component requiring electricity.

In some aspects, the hydrogen fuel cell may also be operated in a shorted condition or electrically connected to an electrical heater. This allows the hydrogen fuel cell to deliver large amounts of thermal energy at very high efficiency. Thus, the hydrogen fuel cell may be flexibly used as a source of electrical energy and thermal energy as desired or required by system specifications or customer demand.

The system may further comprise a hydrogen storage system. The hydrogen storage system may be in fluid communication with the electrolyzer module. The hydrogen storage system may also be in fluid communication with the hydrogen fuel cell. The electrolyzer module may transfer generated hydrogen gas into the hydrogen storage system. The stored hydrogen may then be transferred to the hydrogen fuel cell, to an external hydrogen load (e.g., a catalytic combustion reactor), and/or the stored hydrogen may continue to be stored for future use.

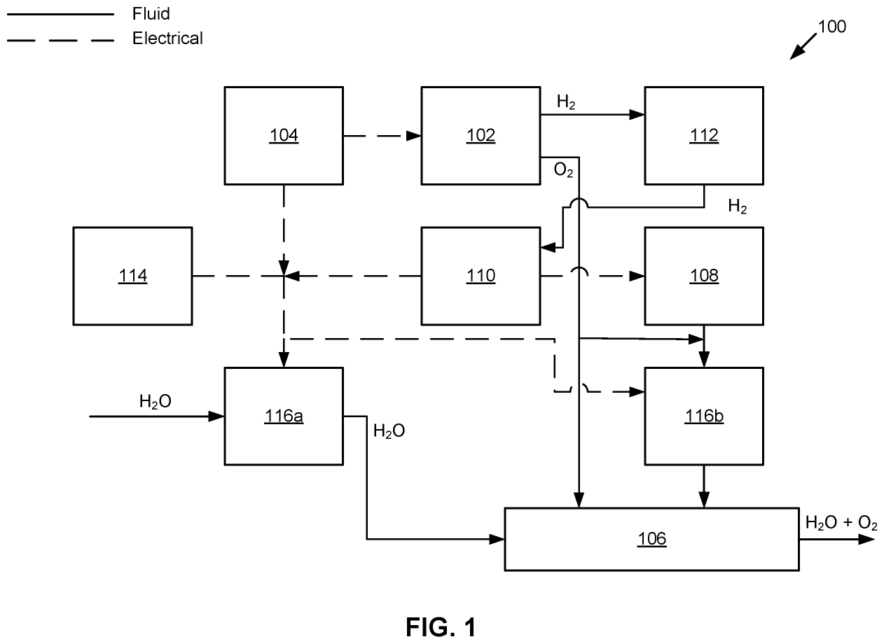

Referring now to FIG. 1, an exemplary system 100 of the present disclosure comprises an electrolyzer module 102 fluidly connected to a hydrogen storage system 112. The electrolyzer module 102 is electrically connected to a photovoltaic panel 104. The electrolyzer module 102 is also fluidly connected to the water supply 106 to provide oxygen to the water supply 106. The hydrogen storage system 112 is fluidly connected to a hydrogen fuel cell 110, which is electrically connected to an energy storage system 114, a first pump 116a, and a second pump 116b. The photovoltaic panel 104 is also electrically connected to the energy storage system 114, the first pump 116a, and the second pump 116b. The system 100 also comprises a water-capture unit 108 which is fluidly connected to the water supply 106. The second pump 116b is fluidly connected with the water-capture unit 108 and the water supply 106 to pressurize the water flowing from the water-capture unit 108 to the water supply 106. The system 100 is therefore operable to provide a continuous supply of pressurized water: during the day, the photovoltaic panel 104 provides power to the first pump 116a and to the second pump 116b to generate pressurized water, whereas at night the fuel cell 110 produces electricity from the stored hydrogen produced in the electrolyzer module 102 to supply power to the first pump 116a and to the second pump 116b to generate pressurized water.

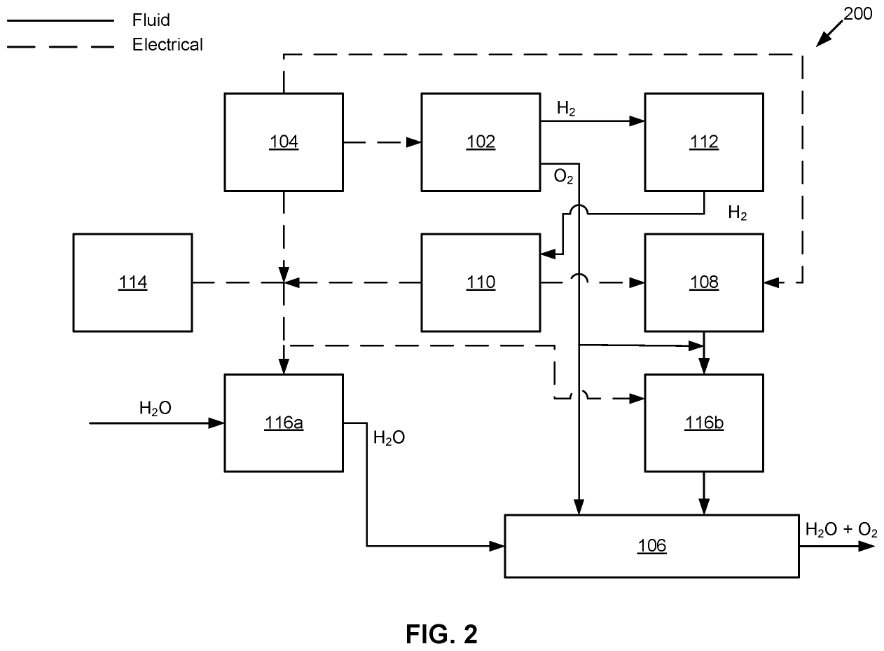

Referring now to FIG. 2, an exemplary system 200 of the present disclosure comprises an electrolyzer module 102 fluidly connected to a hydrogen storage system 112. The electrolyzer module 102 is electrically connected to a photovoltaic panel 104. The electrolyzer module 102 is also fluidly connected to the water supply 106 to provide oxygen to the water supply 106. The hydrogen storage system 112 is fluidly connected to a hydrogen fuel cell 110, which is electrically connected to an energy storage system 114, a first pump 116a, and a second pump 116b. The photovoltaic panel 104 is also electrically connected to the energy storage system 114, the first pump 116a, and the second pump 116b. The system 200 also comprises a water-capture unit 108 which is fluidly connected to the water supply 106. The water capture unit 108 is electrically connected to the photovoltaic panel 104 and to the hydrogen fuel cell 112. The second pump 116b is fluidly connected with the water-capture unit 108 and the water supply 106 to pressurize the water flowing from the water-capture unit 108 to the water supply 106. The system 200 is therefore operable to provide a continuous supply of pressurized water: during the day, the photovoltaic panel 104 provides power to the first pump 116a and to the second pump 116b to generate pressurized water, whereas at night the fuel cell 110 produces electricity from the stored hydrogen produced in the electrolyzer module 102 to supply power to the first pump 116a and to the second pump 116b to generate pressurized water.

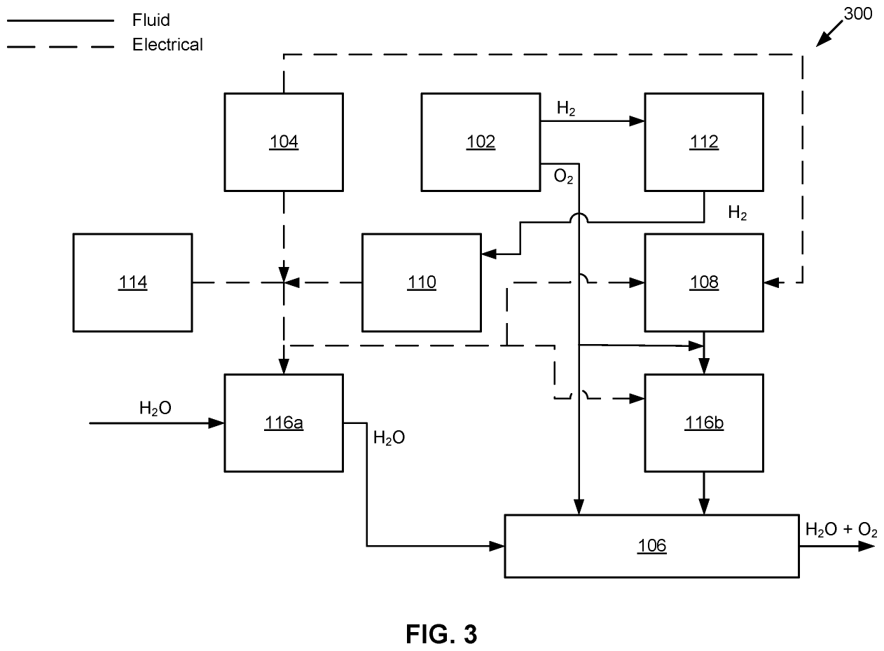

Referring now to FIG. 3, an exemplary system 300 of the present disclosure comprises an electrolyzer module 102 fluidly connected to a hydrogen storage system 112. The electrolyzer module 102 is also fluidly connected to the water supply 106 to provide oxygen to the water supply 106. The hydrogen storage system 112 is fluidly connected to a hydrogen fuel cell 110, which is electrically connected to an energy storage system 114, a first pump 116a, and a second pump 116b. The photovoltaic panel 104 is also electrically connected to the energy storage system 114, the first pump 116a, and the second pump 116b. The system 300 also comprises a water-capture unit 108 which is fluidly connected to the water supply 106. The water capture unit 108 is electrically connected to a photovoltaic panel 104 and to a hydrogen fuel cell 110. The second pump 116b is fluidly connected with the water-capture unit 108 and the water supply 106 to pressurize the water flowing from the water-capture unit 108 to the water supply 108. The system 300 is therefore operable to provide a continuous supply of pressurized water: during the day, the photovoltaic panel 104 provides power to the first pump 116a and to the second pump 116b to generate pressurized water, whereas at night the fuel cell 110 produces electricity from the stored hydrogen produced in the electrolyzer module 102 to supply power to the first pump 116a and to the second pump 116b to generate pressurized water.

Further provided herein are methods for generating a continuous supply of water. The methods generally use the systems of the present disclosure. The methods generally include producing hydrogen via an electrolyzer module and producing water via a water-capture unit electrically connected to a photovoltaic panel and to a hydrogen fuel cell. The water-capture unit is powered by the photovoltaic panel when the photovoltaic panel is receiving sunlight (i.e., during the day). When the photovoltaic panel is not receiving sunlight (i.e., during the night), the water-capture unit is powered by the hydrogen fuel cell. The electrolyzer module, the water-capture unit, the photovoltaic panel, and the hydrogen fuel cell may be any of those described hereinabove.

The method may further comprise storing excess electricity generated by the photovoltaic panel in an energy storage system. The energy storage system may be any energy storage system described herein. The method may also include powering the water-capture unit and/or the electrolyzer module using energy stored in the energy storage device. This is particularly useful at times when the photovoltaic cell is not producing electricity or is producing an insufficient amount of electricity (e.g., when the sun is not shining).

The method may further comprise diffusing oxygen produced by the electrolyzer into a water supply. The diffusing may be accomplished using a diffuser as described hereinabove. The oxygen may be diffused into the water generated by the water-capture unit. The method may further comprise detecting the oxygen concentration in the water via an oxygen sensor. The oxygen sensor may be any oxygen sensor described herein. In particular embodiments, the method may further include increasing or decreasing the flow rate of oxygen produced by the electrolyzer module in response to the oxygen concentration detected by the oxygen sensor. The flow rate may increase or decrease by opening or closing a valve in fluid communication with the electrolyzer module. The valve may open and close in response to an electrical communication received from a controller as described herein. For example, if the oxygen concentration reaches a predetermined maximum value, the valve may close to reduce the flow rate of oxygen. Alternatively, the valve may redirect a portion of the oxygen to an oxygen storage system or an oxygen load; therefore, the method may further comprise storing the produced oxygen in an oxygen storage system. As another example, if the oxygen concentration reaches a predetermined minimum value, the valve may open to increase the flow rate of oxygen.

### Definitions

When introducing elements of the embodiments described herein, the articles “a”, “an”, “the” and “said” are intended to mean that there are one or more of the elements. The terms “comprising”, “including” and “having” are intended to be inclusive and mean that there may be additional elements other than the listed elements.

As used herein, a “fluid” connection is a connection that allows for or facilitates the transfer of fluids including liquids and gases. Non-limiting examples of fluid connections include pipes, manifolds, ducts, valves, hoses, couplings, tubes, etc. Components which are in “fluid communication” with one another are understood to have one or more fluid connections with one another.

As used herein, an “electrical” connection is a connection that allows for or facilitates the transfer of electricity. Non-limiting examples of electrical connections include wires, cables, power lines, breakers, transformers, converters, rectifiers, switches, etc. Components which are in “electrical communication” with one another are understood to have one or more electrical connections with one another.

As used herein, a “thermal” connection is a connection that allows for or facilitates the transfer of heat from one medium to another. Thermal connections may include heat exchangers, such as shell and tube heat exchangers, plate heat exchangers, plate and shell heat exchangers, adiabatic wheel heat exchangers, plate fin heat exchangers, finned tube heat exchangers, pillow plate heat exchangers, phase-change heat exchangers, and other heat exchangers known in the art. Components which are in “thermal communication” with one another are understood to have one or more thermal connections with one another.

As used herein, an “operable” connection includes any connection that allows for or facilitates the operation of a system unit or process. An operable connection may include an electrical connection and/or a fluid connection.

All documents mentioned herein are hereby incorporated by reference in their entirety. References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Thus, the term “or” should generally be understood to mean “and/or,” and the term “and” should generally be understood to mean “and/or.”

Recitation of ranges of values herein are not intended to be limiting, referring instead individually to any and all values falling within the range, unless otherwise indicated herein, and each separate value within such a range is incorporated into the specification as if it were individually recited herein. The words “about,” “approximately,” or the like, when accompanying a numerical value, are to be construed as including any deviation as would be appreciated by one of ordinary skill in the art to operate satisfactorily for an intended purpose. Ranges of values and/or numeric values are provided herein as examples only, and do not constitute a limitation on the scope of the described embodiments. The use of any and all examples or exemplary language (“e.g.,” “such as,” or the like) is intended merely to better illuminate the embodiments and does not pose a limitation on the scope of those embodiments. No language in the specification should be construed as indicating any unclaimed element as essential to the practice of the disclosed embodiments.

It will be appreciated that the methods and systems described above are set forth by way of example and not of limitation. Numerous variations, additions, omissions, and other modifications will be apparent to one of ordinary skill in the art. In addition, the order or presentation of method steps in the description and drawings above is not intended to require this order of performing the recited steps unless a particular order is expressly required or otherwise clear from the context. Thus, while particular embodiments have been shown and described, it will be apparent to those skilled in the art that various changes and modifications in form and details may be made therein without departing from the scope of the disclosure.

What is claimed is:

1. A system for generating a continuous supply of water comprising:
an electrolyzer module fluidly connectable to a hydrogen storage system; and
a water-capture unit for generating water, the water-capture unit electrically connectable to a photovoltaic panel and to a hydrogen fuel cell.

2. The system of claim 1, wherein the water capture unit comprises a hydropanel, a dehumidifier, a filtered waste water stream, a rainwater capture system, a river water capture system, a lake water capture system, an ocean capture system, or any combination thereof.

3. The system of claim 1, wherein the hydrogen fuel cell is fluidly connected to the hydrogen storage system.

4. The system of claim 3, wherein the hydrogen fuel cell is electrically connected to an electricity storage system.

5. The system of claim 3, wherein the hydrogen fuel cell is electrically connected to a pump.

6. The system of claim 1, further comprising a first pump fluidly connected to the water-capture unit and to the water supply.

7. The system of claim 1, further comprising a water storage system fluidly connected to the water-capture unit and a second pump fluidly connected to the water storage system and to the water-capture unit.

8. The system of claim 1, further comprising a thermal loop in thermal communication with the electrolyzer module, the thermal loop including a circulating heat exchange fluid.

9. The system of claim 8, wherein the thermal loop comprises a third pump operable to pump the circulating heat exchange fluid through the thermal loop.

10. The system of claim 8, the thermal loop further including a solar thermal system.

11. The system of claim 8, the thermal loop further including a heat load.

12. The system of claim 1, wherein the hydrogen fuel cell provides electricity to the water-capture unit when the photovoltaic panel is not producing electricity.

13. The system of claim 1, further comprising an electricity storage system electrically connected to the photovoltaic panel.

14. The system of claim 1, wherein the electrolyzer module is operable to provide oxygen to the water supply, thereby increasing the oxygen concentration of the water in the water supply.

15. A system for generating a continuous supply of water comprising:
an electrolyzer module electrically connected to a photovoltaic panel and fluidly connected to a hydrogen storage system;
a water-capture unit for generating water, the water-capture unit electrically connected to the photovoltaic panel;
a hydrogen fuel cell fluidly connected to the hydrogen storage system and electrically connected to the water-capture unit; and
a thermal loop including a circulating heat exchange fluid thermally connected to the electrolyzer module, the hydrogen fuel cell, and a heat load.

16. A method for generating a continuous supply of water comprising:
producing hydrogen via an electrolyzer module, and
producing water via a water-capture unit electrically connected to a photovoltaic panel and to a hydrogen fuel cell, wherein:
the water-capture unit is powered by the photovoltaic panel when the photovoltaic panel is receiving sunlight,
the water-capture unit is powered by the hydrogen fuel cell when the photovoltaic panel is not receiving sunlight; and
the hydrogen fuel cell produces electricity using the hydrogen produced by the electrolyzer module.

17. The method of claim 16, further comprising storing the produced hydrogen in a hydrogen storage system fluidly connected to the hydrogen fuel cell.

18. The method of claim 16, wherein the electrolyzer further produces oxygen and the method further comprises diffusing the produced oxygen in a water supply.

19. The method of claim 16, wherein the water-capture unit comprises a hydropanel, a dehumidifier, a filtered waste water stream, a rainwater capture system, a river water capture system, a lake water capture system, an ocean capture system, or any combination thereof.

20. The method of claim 16, wherein the electrolyzer module is electrically connected to the photovoltaic panel.
